(19) United States
(12) Patent Application Publication
(10) Pub. No.: US 2025/0224589 A1
(43) Pub. Date: Jul. 10, 2025

(54) LENS APPARATUS AND IMAGE PICKUP APPARATUS

(71) Applicant: CANON KABUSHIKI KAISHA, Tokyo (JP)

(72) Inventor: SHIGEHIRO TORII, Saitama (JP)

(21) Appl. No.: 18/958,538

(22) Filed: Nov. 25, 2024

(30) Foreign Application Priority Data
Jan. 10, 2024 (JP) 2024-001600

(51) Int. Cl. G02B 7/06

(52) U.S. Cl. CPC G02B 7/06

(57) ABSTRACT

A lens apparatus includes a first optical system, a second optical system disposed in parallel with the first optical system, a base member configured to hold the first optical system and the second optical system movably in an optical axis direction, a first drive unit configured to move the base member in the optical axis direction, a first holder configured to hold a part of a plurality of lenses constituting the second optical system, and a second drive unit configured to move the first holder in the optical axis direction.

### BACKGROUND

### Technical Field

The disclosure relates to a lens apparatus and an image pickup apparatus.

### Description of Related Art

Interchangeable lenses for three-dimensional imaging have conventionally been known. In a lens apparatus including two optical systems arranged in parallel and configured to form two image circles in parallel on a single image sensor, focusing is to be performed on each of the two optical systems in order to capture images with parallax. Japanese Patent Application Laid-Open No. 2023-37539 discloses a lens apparatus that includes a first focusing unit configured to perform focusing for a first optical system and a second optical system simultaneously, and a second focusing unit configured to adjust a relative focus position shift between the first optical system and the second optical system. The first focusing unit is connected to both the first optical system and the second optical system, and the second focusing unit is connected to one of the first optical system and the second optical system.

### SUMMARY

A lens apparatus according to one aspect of the disclosure includes a first optical system, a second optical system disposed in parallel with the first optical system, a base member configured to hold the first optical system and the second optical system movably in an optical axis direction, a first drive unit configured to move the base member in the optical axis direction, a first holder configured to hold a part of a plurality of lenses constituting the second optical system, and a second drive unit configured to move the first holder in the optical axis direction. An image pickup apparatus having the above lens apparatus also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a perspective view of an image pickup apparatus according to a first embodiment.

FIG. 2 is an exploded perspective view of a lens unit according to the first embodiment.

FIG. 3 is a front view of the lens unit according to the first embodiment.

FIG. 4 is a side view of the lens unit according to the first embodiment.

FIG. 5 is a front view of a lens unit according to a second embodiment.

FIG. 6 is a side view of the lens unit according to the second embodiment.

FIG. 7 is a front view of a lens unit according to a third embodiment.

FIG. 8 is a side view of the lens unit according to the third embodiment.

### DETAILED DESCRIPTION

Referring now to the accompanying drawings, a detailed description will be given of embodiments according to the disclosure.

### First Embodiment

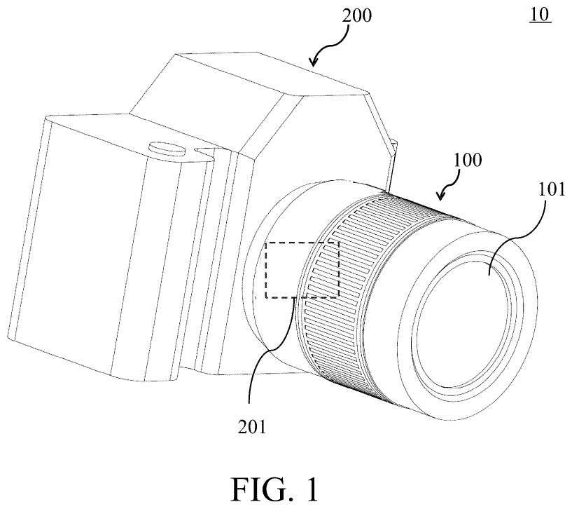

Referring now to FIGS. 1 to 4, a description will be given of a first embodiment of the present disclosure. FIG. 1 is a perspective view of an image pickup apparatus 10 according to this embodiment. The image pickup apparatus 10 includes a camera body 200 and a lens apparatus (interchangeable lens) 100 attachable to and detachable from the camera body 200. However, this embodiment is not limited to this example, and is applicable to an image pickup apparatus in which the camera body and the lens apparatus are integrated.

The lens apparatus 100 is attachable to and detachable from the camera body 200 via a mount (not illustrated). The lens apparatus 100 includes a lens unit 101, a control unit (not illustrated), a lens drive instruction unit, and a contact unit that can communicate with the camera body 200. The camera body 200 includes an image sensor 201 such as a CMOS sensor, a control unit (not illustrated), and a contact unit that can communicate with the lens apparatus 100. The image sensor 201 is a single image sensor that photoelectrically converts each of a first optical image formed by a first optical system and a second optical image formed by a second optical system arranged in parallel with the first optical system.

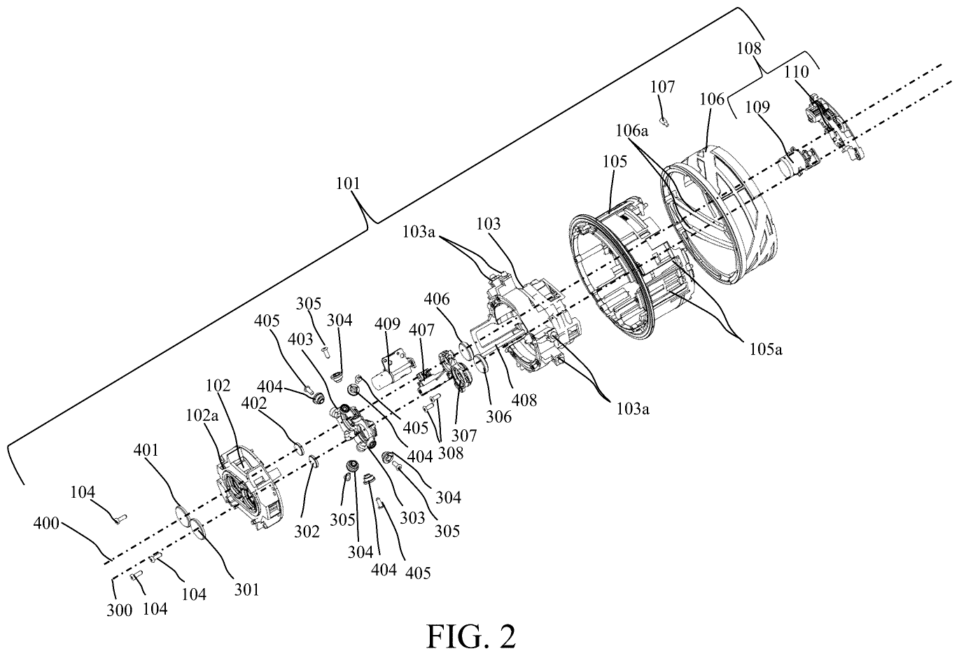

FIG. 2 is an exploded perspective view of the lens unit 101 according to this embodiment. The lens unit 101 includes a first optical system and a second optical system arranged in parallel with the first optical system. The first optical system includes a plurality of lenses including a first lens 301, a second lens 302, and a third lens 306, which are arranged in this order from the object side to the image side along the direction of a first optical axis 300. The first optical system is a coaxial optical system because the central axes of all the lenses constituting the first optical system are the first optical axis 300. The second optical system includes a plurality of lenses including a first lens 401, a second lens 402, and a third lens 406, which are arranged in this order from the object side to the image side along the direction of a second optical axis 400. Similarly to the first optical system, the second optical system is also a coaxial optical system because the central axes of all the lenses constituting the second optical system are the second optical axis 400.

A first lens holding barrel 102 holds the first lens 301 of the first optical system and the first lens 401 of the second optical system. A second lens holding barrel (second holder) 303 holds the second lens 302 of the first optical system. A second lens holding barrel (third holder) 403 holds the second lens 402 of the second optical system. That is, the second lens holding barrel 303 holds at least a part of the lenses of the first optical system, and the second lens holding barrel 403 is arranged in parallel with the second lens holding barrel 303 and holds at least a part of the lenses of the second optical system.

The second lens holding barrel 303 is fixed to a groove portion 102a in the first lens holding barrel 102 using rollers 304 and screws 305, and its position is determined. The rollers 304 are eccentric rollers (second position adjuster) configured to adjust and determine the position of the second lens holding barrel 303. Similarly, the second lens holding barrel 403 is fixed to the first lens holding barrel 102 using rollers 404 and screws 405, and its position is determined. The rollers 404 are eccentric rollers (third position adjuster) configured to adjust and determine the position of the second lens holding barrel 403.

A third lens holding barrel 307 holds a third lens 306 in the first optical system. The third lens holding barrel (first holder) 407 holds a third lens 406 in the second optical system. That is, the third lens holding barrel 407 holds a part of the plurality of lenses in the second optical system. The third lens holding barrel 307 is fixed to a base member (main base) 103 with screws 308, and its position is determined.

The third lens holding barrel 407 is an adjuster configured to adjust a focus difference between the first optical system and the second optical system (a relative focus position shift between the first optical system and the second optical system).

The third lens holding barrel 407 can be moved back and forth in a direction along the second optical axis 400 (optical axis direction) by a guide bar 408 sandwiched between the first lens holding barrel 102 and the base member 103, and a focus-difference adjusting drive unit (second drive unit) 409. Thus, the focus-difference adjusting drive unit 409 moves the third lens holding barrel 407 in the optical axis direction. The focus-difference adjusting drive unit 409 is electrically connected to a fixed substrate (not illustrated) by a flexible printed circuit (not illustrated). The focus-difference adjusting drive unit 409 drives the third lens holding barrel 407 (only a part of all the lenses constituting the second optical system) to adjust the focus difference between the first optical system and the second optical system (a relative focus position shift between the first optical system and the second optical system) (performs focus difference adjustment). Thus, the driving load is light, and the size of the driving actuator can be reduced. As a result, the size of the lens apparatus 100 can be reduced.

Since the third lens holding barrel 307 is a fixed unit, the focus difference adjusting accuracy is higher than that in a configuration in which the third lens holding barrel 307 is a focusing unit similar to the third lens holding barrel 407. The first lens holding barrel 102 is fixed to the base member 103 with screws 104 to determine its position. A cam follower 103a of the base member 103 is inserted into a linear groove 105a in a guide barrel 105 and a cam groove 106a in a cam ring 106. Due to the rotation of the cam ring 106, the first lens holding barrel 102 can be moved back and forth in the direction along the first optical axis 300 and the second optical axis 400 (optical axis direction). A rotating range of the cam ring 106 is restricted by screws 107.

A focus drive unit (first drive unit) 108 includes a driving source 109 and a transmission unit 110, and is fixed to the guide barrel 105 with a screw (not illustrated). The focus drive unit 108 is electrically connected to a fixed substrate (not illustrated) via a flexible printed circuit (not illustrated). The rotation of the driving source 109 rotates the cam ring 106 via the transmission unit 110, and moves the base member 103 forward and backward in a direction along the first optical axis 300 and the second optical axis 400 (the optical axis direction). Thus, the focus drive unit 108 moves the base member 103 in the optical axis direction, thereby performing focusing for the first optical system and the second optical system simultaneously.

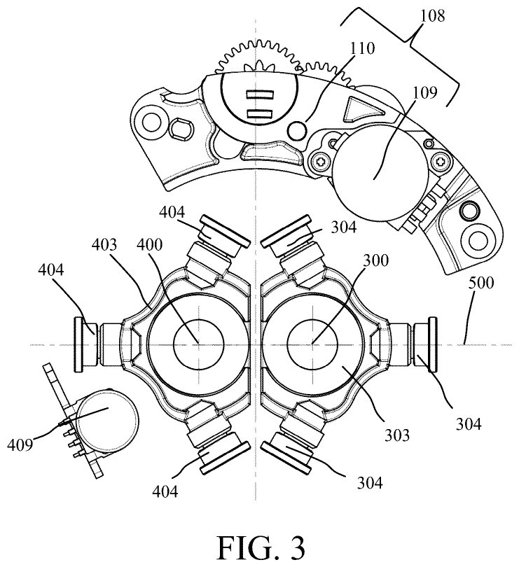

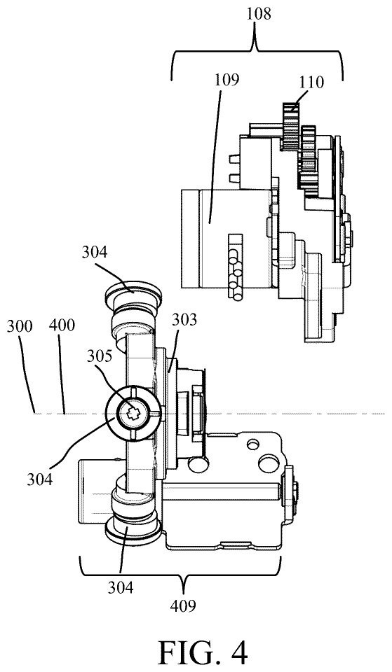

FIG. 3 is a front view of the lens unit 101 according to this embodiment viewed from a direction along the first optical axis 300 and the second optical axis 400 (or on a plane orthogonal to the first optical axis 300 and the second optical axis 400). FIG. 4 is a side view of the lens unit 101 viewed from a direction perpendicular to each of the first optical axis 300 and the second optical axis 400 (a direction in which the first optical axis 300 and the second optical axis 400 overlap each other). FIGS. 3 and 4 respectively illustrate only the second lens holding barrel 303, rollers 304, screws 305, second lens holding barrel 403, rollers 404, screws 405, focus-difference adjusting drive unit 409, and focus drive unit 108 selected from the lens unit 101.

As illustrated in FIG. 3, when the lens unit 101 (lens apparatus 100) is viewed along the optical axis direction, the focus-difference adjusting drive unit 409 is disposed at a position that avoids (shifts from) a straight line 500 connecting the first optical axis 300 and the second optical axis 400 (so as not to overlap the straight line 500). When the lens unit 101 is viewed along the optical axis direction, the focus-difference adjusting drive unit 409 is disposed at a position that avoids (shifts from) the rollers 304 and 404 (so as not to overlap the rollers 304 and 404, i.e., in a different phase). When the lens unit 101 is viewed along the optical axis direction, the driving source 109 of the focus drive unit 108 is disposed so as not to overlap the focus-difference adjusting drive unit 409. This arrangement can reduce the size of the lens apparatus 100 in the radial direction.

As illustrated in FIG. 4, when the lens unit 101 is viewed from the direction in which the first optical axis 300 and the second optical axis 400 overlap each other, at least a part of the focus drive unit 108 and at least a part of the focus-difference adjusting drive unit 409 are arranged so as to overlap each other at a position along the optical axis direction (or so that they cross a straight line perpendicular to the optical axis direction or they are disposed on a plane perpendicular to the optical axis direction). When the lens unit 101 is viewed from the direction in which the first optical axis 300 and the second optical axis 400 overlap each other, at least a part of the focus-difference adjusting drive unit 409 and the rollers 304 and 404 are arranged to overlap each other. This arrangement can reduce the size of the lens apparatus 100 in the overall length direction (optical axis direction).

### Second Embodiment

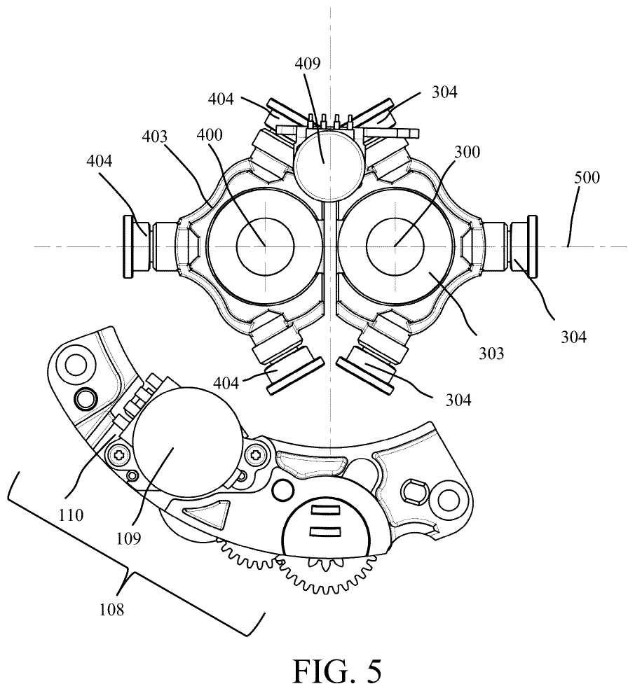

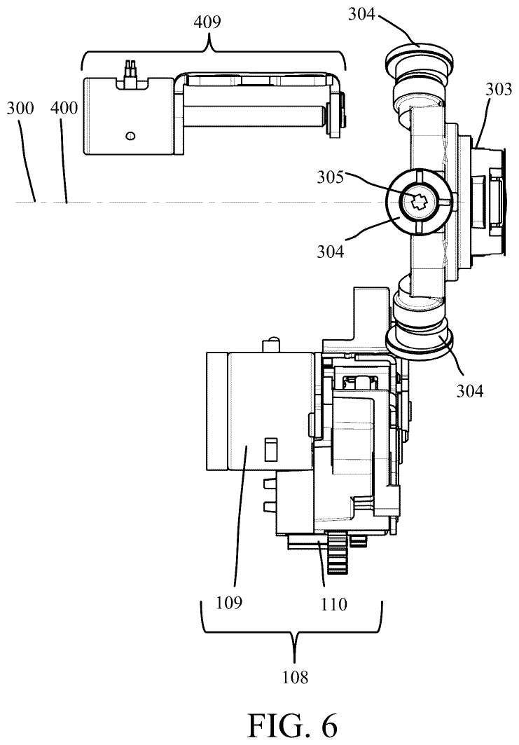

Referring now to FIGS. 5 and 6, a description will be given of a second embodiment of the present disclosure. FIG. 5 is a front view of the lens unit 101 according to this embodiment viewed from a direction along the first optical axis 300 and the second optical axis 400. FIG. 6 is a side view of the lens unit 101 viewed from a direction perpendicular to each of the first optical axis 300 and the second optical axis 400 (a direction in which the first optical axis 300 and the second optical axis 400 overlap each other).

As illustrated in FIG. 5, when the lens unit 101 (lens apparatus 100) is viewed along the optical axis direction, the focus-difference adjusting drive unit 409 is disposed at a position that avoids the straight line 500 that connects the first optical axis 300 and the second optical axis 400. The focus-difference adjusting drive unit 409 is also disposed at a position that overlaps at least a part of the rollers 304 and 404. The driving source 109 of the focus drive unit 108 is also disposed at a position that does not overlap the focus-difference adjusting drive unit 409. This arrangement can reduce the size of the lens apparatus 100 in the radial direction.

As illustrated in FIG. 6, when the lens unit 101 is viewed from the direction in which the first optical axis 300 and the second optical axis 400 overlap each other, at least a part of the focus-difference adjusting drive unit 409 and at least a part of the focus drive unit 108 are arranged so as to overlap each other at a position along the optical axis direction (or so that they cross a straight line perpendicular to the optical axis direction or they are disposed on a plane perpendicular to the optical axis direction). This arrangement can reduce the size of the lens apparatus 100 in the overall length direction.

### Third Embodiment

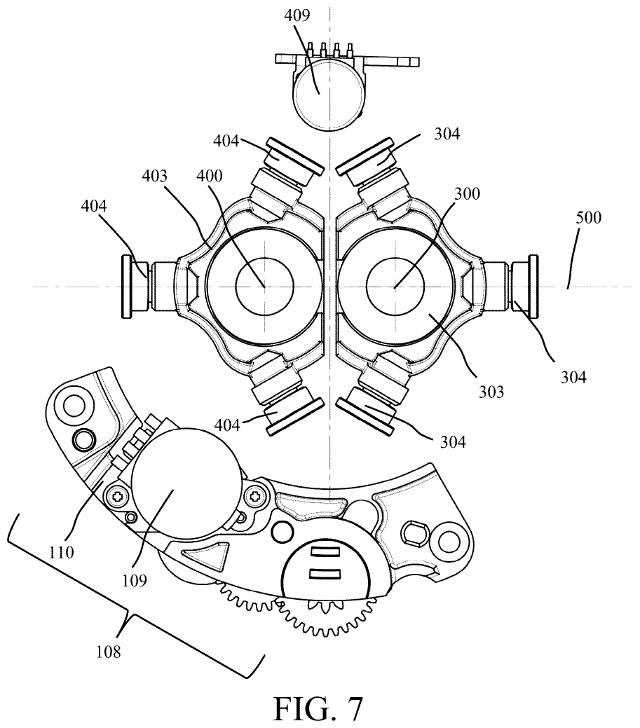

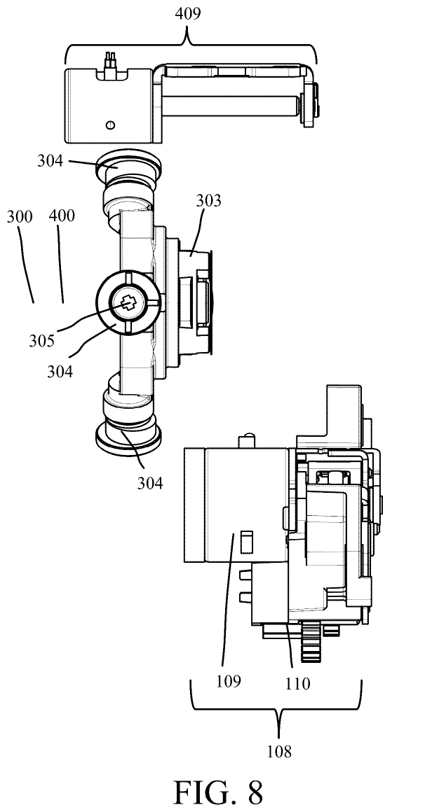

Referring now to FIGS. 7 and 8, a description will be given of a third embodiment of the present disclosure. FIG. 7 is a front view of the lens unit 101 according to this embodiment viewed from a direction along the first optical axis 300 and the second optical axis 400. FIG. 8 is a side view of the lens unit 101 viewed from a direction perpendicular to each of the first optical axis 300 and the second optical axis 400 (a direction in which the first optical axis 300 and the second optical axis 400 overlap each other).

As illustrated in FIG. 7, when the lens unit 101 (lens apparatus 100) is viewed along the optical axis direction, the focus-difference adjusting drive unit 409 is disposed at a position that avoids the straight line 500 that connects the first optical axis 300 and the second optical axis 400. When the lens unit 101 is viewed along the optical axis direction, the focus-difference adjusting drive unit 409 is disposed at a position that does not overlap the rollers 304 and 404. The driving source 109 of the focus drive unit 108 is disposed at a position that does not overlap with the focus-difference adjusting drive unit 409. This arrangement can reduce the radial size of the lens apparatus 100.

As illustrated in FIG. 8, when the lens unit 101 is viewed from the direction in which the first optical axis 300 and the second optical axis 400 overlap each other, at least a part of the focus-difference adjusting drive unit 409 and at least a part of the focus drive unit 108 are arranged so as to overlap each other at positions along the optical axis direction (or so that they cross a straight line perpendicular to the optical axis direction or they are disposed on a plane perpendicular to the optical axis direction). When the lens unit 101 is viewed from the direction in which the first optical axis 300 and the second optical axis 400 overlap each other, the focus-difference adjusting drive unit 409 and the rollers 304 and 404 are arranged so as to overlap each other at least partially. This arrangement can reduce the size of the lens apparatus 100 in the overall length direction.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide a lens apparatus that has a reduced size.

This application claims priority to Japanese Patent Application No. 2024-001600, which was filed on Jan. 10, 2024, and which is hereby incorporated by reference herein in its entirety.

What is claimed is:

1. A lens apparatus comprising:
a first optical system;
a second optical system disposed in parallel with the first optical system;
a base member configured to hold the first optical system and the second optical system movably in an optical axis direction;
a first drive unit configured to move the base member in the optical axis direction;
a first holder configured to hold a part of a plurality of lenses constituting the second optical system; and
a second drive unit configured to move the first holder in the optical axis direction.

2. The lens apparatus according to claim 1, wherein in a case where the lens apparatus is viewed along the optical axis direction, the second drive unit is disposed so as not to overlap a straight line connecting a first optical axis of the first optical system and a second optical axis of the second optical system, and the first drive unit is disposed so as not to overlap the second drive unit.

3. The lens apparatus according to claim 1, wherein in a case where the lens apparatus is viewed in a direction perpendicular to a first optical axis of the first optical system and a second optical axis of the second optical system, in which the first optical axis and the second optical axis overlap each other, at least a part of the first drive unit and at least a part of the second drive unit overlap each other at a position along the optical axis direction.

4. The lens apparatus according to claim 1, wherein each of the first optical system and the second optical system is a coaxial optical system.

5. The lens apparatus according to claim 1, wherein the first drive unit includes a driving source and a transmission unit, and
wherein in a case where the lens apparatus is viewed along the optical axis direction, the driving source is disposed so as not to overlap the second drive unit.

6. The lens apparatus according to claim 1, wherein the first drive unit moves the base member in the optical axis direction to perform focusing for the first optical system and the second optical system simultaneously, and
wherein the second drive unit moves the part of the plurality of lenses constituting the second optical system in the optical axis direction to perform focus difference adjustment that adjusts a relative focus position shift between the first optical system and the second optical system.

7. The lens apparatus according to claim 1, further comprising:
a second holder configured to hold at least a part of lenses of the first optical system; and
a third holder disposed in parallel with the second holder and configured to hold at least a part of lenses of the second optical system,
wherein the second holder includes a second position adjuster configured to adjust a position of the second holder, and
wherein the third holder includes a third position adjuster configured to adjust a position of the third holder.

8. The lens apparatus according to claim 7, wherein when the lens apparatus is viewed in a direction perpendicular to each of a first optical axis of the first optical system and a second optical axis of the second optical system, in which the first optical axis and the second optical axis overlap each other, the second drive unit is disposed so as to overlap each of the second position adjuster and the third position adjuster, and
wherein in a case where the lens apparatus is viewed along the optical axis direction, the second drive unit is disposed so as not to overlap each of the second position adjuster and the third position adjuster.

9. The lens apparatus according to claim 7, wherein the second position adjuster is configured to adjust and determine the position of the second holder, and
wherein the third position adjuster is configured to adjust and determine the position of the third holder.

10. An image pickup apparatus comprising:
a lens apparatus; and
an image sensor
wherein the lens apparatus includes:
a first optical system;
a second optical system disposed in parallel with the first optical system;
a base member configured to hold the first optical system and the second optical system movably in an optical axis direction;
a first drive unit configured to move the base member in the optical axis direction;
a first holder configured to hold a part of a plurality of lenses constituting the second optical system; and
a second drive unit configured to move the first holder in the optical axis direction.

11. The image pickup apparatus according to claim 10, wherein the image sensor is a single image sensor configured to photoelectrically convert a first optical image formed by the first optical system and a second optical image formed by the second optical system.
